(19) United States
(12) Patent Application Publication
(10) Pub. No.: US 2026/0129669 A1
(43) Pub. Date: May 7, 2026

(54) METHOD FOR SENDING INDICATION INFORMATION, METHOD FOR RECEIVING INDICATION INFORMATION, AND APPARATUS AND READABLE STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 19/114,550

(22) PCT Filed: Sep. 30, 2022
(86) PCT No.: PCT/CN2022/123532

§ 371 Date: Mar. 24, 2025

(51) Int. Cl. H04W 72/566; H04W 72/0446; H04W 72/231

(52) U.S. Cl. CPC H04W 72/566; H04W 72/0446; H04W 72/231

(57) ABSTRACT

Provided in the present disclosure are a method for sending indication information, a method for receiving indication information, and an apparatus and a readable storage medium. The method for receiving indication information comprises: receiving indication information, which is sent by a network device, wherein the indication information is used for indicating the priority of a sensing signal and/or the priority of a cellular signal; and when there is a conflict between a time-domain resource for the sensing signal and a time-domain resource for the cellular signal, sending and receiving the sensing signal or the cellular signal according to the indication information.

### CROSS REFERENCE TO RELATED APPLICATIONS

This application is a US National Phase of a PCT Application No. PCT/CN2022/123532 filed on Sep. 30, 2022, the entire contents of which are incorporated herein by reference in their entireties.

### TECHNICAL FIELD

The present disclosure relates to the field of wireless communication technology, particularly to methods for transmitting or receiving indication information, apparatuses and readable storage media.

### BACKGROUND

Wireless Sensing technology can achieve, based on existing wireless networks and devices, motion detection, gesture recognition, and biometric measurement by analyzing the changes in sensing signals such as Wireless Fidelity (Wi-Fi) signals during propagation, without the need for the detected object to wear any devices. Where a transmitting end can transmit multiple sensing signals for a receiving end to analyze and apply.

For user equipment (UE) that supports the ability to transmit and receive sensing signals, when the UE transmits or receives sensing signals, the sensing signals transmitted or received by the UE may conflict with cellular signals, and this problem needs to be addressed.

### SUMMARY

The present disclosure provides methods for transmitting or receiving indication information, apparatuses and readable storage media.

In the first aspect, the present disclosure provides a method for receiving indication information, performed by user equipment, including: receiving indication information transmitted by a network device, where the indication information is configured to indicate priority of a sensing signal and/or priority of a cellular signal; and in response to a conflict between a time-domain resource of the sensing signal and a time-domain resource of the cellular signal, transmitting or receiving the sensing signal or the cellular signal according to the indication information.

In the methods of the present disclosure, the user equipment determines the priority of at least one of the sensing signal or the cellular signal based on the indication information transmitted by the network device, such that when there is a time-domain conflict between the sensing signal and the cellular signal, the user equipment can perform reasonable scheduling based on the priority.

In some embodiments, the transmitting or receiving the sensing signal or the cellular signal based on the indication information includes: in response to the priority of the cellular signal being higher than the priority of the sensing signal, transmitting or receiving the cellular signal.

In some embodiments, the transmitting or receiving the sensing signal or the cellular signal based on the indication information includes: in response to the priority of the sensing signal being higher than the priority of the cellular signal, transmitting or receiving the sensing signal according to configuration information, where the configuration information includes a measurement gap for transmitting or receiving the sensing signal.

In some embodiments, transmitting or receiving the sensing signal or the cellular signal based on the indication information includes: according to the configuration information, transmitting or receiving the sensing signal within a time-domain resource corresponding to the measurement gap.

In some embodiments, the method further includes: receiving configuration information transmitted by the network device.

In some embodiments, the method further includes: transmitting assistance information to the network device, where the assistance information includes at least one parameter for a measurement gap.

In some embodiments, the at least one parameter includes at least one of: a type of the measurement gap being periodic or non-periodic; measurement gap duration; or a time-domain position of the measurement gap.

In some embodiments, transmitting the assistance information to the network device includes: transmitting radio resource control (RRC) signaling to the network device, where the RRC signaling includes the assistance information.

In the second aspect, the present disclosure provides a method for transmitting indication information, performed by network device, including: transmitting indication information to user equipment, where the indication information is configured to indicate priority of a sensing signal and/or priority of a cellular signal.

In the methods of the present disclosure, the network device indicates the priority of at least one of the sensing signal or the cellular signal to the user equipment via the transmitted indication information, such that the user equipment can perform reasonable scheduling based on the priority.

In some embodiments, the method further includes: in response to the priority of the sensing signal being higher than the priority of the cellular signal, transmitting configuration information to the user equipment, where the configuration information includes a measurement gap for transmitting or receiving the sensing signal.

In some embodiments, the method further includes: according to assistance information transmitted by the user equipment, determining configuration information, where the assistance information includes at least one parameter for a measurement gap; and transmitting the configuration information to the user equipment.

In some embodiments, the configuration information includes at least one of following parameters for the measurement gap: a type of the measurement gap being periodic or non-periodic; measurement gap duration; or a time-domain position of the measurement gap.

In some embodiments, the method further includes: not performing downlink scheduling within a time-domain resource corresponding to the measurement gap.

In the third aspect, the present disclosure provides user equipment including a transceiver module and a processing module.

The transceiver module is configured to receive indication information transmitted by network device, where the indication information is configured to indicate priority of a sensing signal and/or priority of a cellular signal; and the processing module is configured to, in response to a conflict between a time-domain resource of the sensing signal and a time-domain resource of the cellular signal, transmit or receive the sensing signal or the cellular signal according to the indication information.

In the fourth aspect, the present disclosure provides network device including a transceiver module.

The transceiver module is configured to transmit indication information to user equipment, where the indication information is configured to indicate priority of a sensing signal and/or priority of a cellular signal.

In the fifth aspect, the present disclosure provides a communication device, including one or more processors, and one or more memories, where the one or more memories are configured to store a computer program; and the one or more processors are configured to execute the computer program, to implement the method according to any one of the embodiments in the first aspect.

In the sixth aspect, the present disclosure provides a communication device, including one or more processors, and one or more memories, where the one or more memories are configured to store a computer program; and the one or more processors are configured to execute the computer program, to implement the method according to any one of the embodiments in the second aspect.

In the seventh aspect, the present disclosure provides a computer-readable storage medium storing instructions, where a computer, when calling and executing the instructions, performs the method according to any one of the embodiments in the first aspect.

In the eighth aspect, the present disclosure provides a computer-readable storage medium storing instructions, where a computer, when calling and executing the instructions, performs the method according to any one of the embodiments in the second aspect.

In the ninth aspect, the present disclosure provides a communication system including user equipment for executing the method according to any one of the embodiments in the first aspect; and a network device for executing the method according to any one of the embodiments in the second aspect.

It is to be understood that the general descriptions and the below detailed descriptions are merely exemplary and explanatory, and are not intended to limit the present disclosure.

### BRIEF DESCRIPTION OF DRAWINGS

The accompanying drawings illustrated herein are used to provide further understanding of the embodiments of the present disclosure and form a part of the present disclosure. The exemplary embodiments and descriptions of the present disclosure are used to explain the present disclosure, and do not constitute an improper limitation of the present disclosure.

Accompanying drawings herein are incorporated into and constitute a part of the specification, illustrate embodiments consistent with the present disclosure, and are combined with the description to explain the principle of the present disclosure.

FIG. 1 is a schematic structural diagram of a wireless communication system provided in the embodiments of the present disclosure.

FIG. 2 is a flowchart of a method for transmitting or receiving indication information provided in the embodiments of the present disclosure.

FIG. 3 is a flowchart of a method for transmitting or receiving configuration information provided in the embodiments of the present disclosure.

FIG. 4 is a flowchart of a method for transmitting or receiving assistance information provided in the embodiments of the present disclosure.

FIG. 5 is a schematic diagram of an apparatus for receiving indication information provided in the embodiments of the present disclosure.

FIG. 6 is a schematic diagram of an apparatus for transmitting indication information provided in the embodiments of the present disclosure.

### DETAILED DESCRIPTION

Further explanation of the embodiments of the present disclosure is provided in conjunction with the accompanying drawings and the detailed description.

Embodiments will be described in detail herein, examples of which are illustrated in the accompanying drawings. When the following descriptions involve the drawings, like numerals in different drawings represent like or similar elements unless stated otherwise. The embodiments described in the following examples do not represent all embodiments consistent with the present disclosure. Rather, they are merely embodiments of devices and methods consistent with some aspects of the present disclosure as recited in the appended claims.

The term used in the embodiments of the present disclosure is for the purpose of describing particular examples only and is not intended to limit the embodiments of the present disclosure. As used in embodiments of the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. As used herein, the term “if” and “in case” may be interpreted as “when” or “upon” or “in response to determining” depending on the context.

The following describes in detail the embodiments of the present disclosure, examples of the embodiments are shown in the accompanying drawings, where identical or similar labels throughout represent identical or similar elements. The embodiments described below with reference to the accompanying drawings are exemplary and intended to explain the present disclosure, but cannot be understood as limiting the present disclosure.

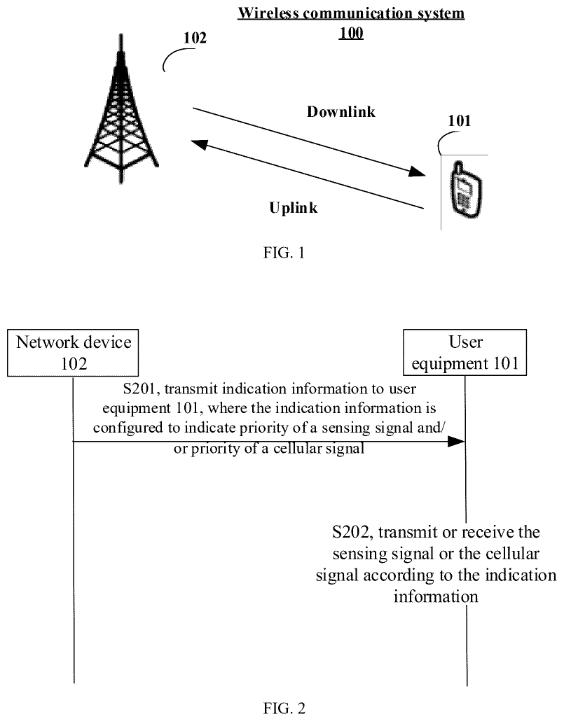

As shown in FIG. 1, the method for transmitting or receiving indication information provided in the embodiments of the present disclosure can be applied to a wireless communication system 100. The wireless communication system 100 may include user equipment 101 and a network device 102. Where the user equipment (UE) 101 is configured to support carrier aggregation and can connect to multiple carrier units of the network device 102. The multiple carrier units include a primary carrier unit and one or more secondary carrier units.

It should be understood that the wireless communication system 100 can be applied to both a low-frequency scenario and a high-frequency scenario. The application scenarios of the wireless communication system 100 include but are not limited to Long Term Evolution (LTE) systems, LTE Frequency Division Duplex (FDD) systems, LTE Time Division Duplex (TDD) systems, Worldwide Interoperability for Microwave Access (WiMAX) communication systems, Cloud Radio Access Network (CRAN) systems, future Fifth Generation (5G) systems, New Radio (NR) communication systems, or future evolved Public Land Mobile Network (PLMN) systems.

The user equipment 101 shown can be a terminal, an access terminal, a terminal unit, a terminal station, a mobile station (MS), a remote station, a remote terminal, a mobile terminal, a wireless communication device, a terminal agent or a terminal device, etc. The user equipment 101 may have wireless transmission and reception capabilities, and can communicate (e.g., wirelessly) with one or more network devices of one or more communication systems and receive a network service provided by the network device, where the network device includes but not limited to the illustrated network device 102.

Where the user equipment 101 can be a cellular phone, a cordless phone, a session initiation protocol (SIP) phone, a wireless local loop (WLL) station, a personal digital assistant (PDA) device, a handheld device with a wireless communication capability, a computing device or other processing device connected to a wireless modem, an in-vehicle device, a wearable device, a terminal device in future 5G networks, or a terminal device in future evolved PLMN networks.

The network device 102 may be an access network device (or access network site). Where the access network device refers to a device that provides network access functions, e.g., a radio access network (RAN) base station, etc. The network device 102 may specifically include a base station (BS), or include a base station and a wireless resource management device for controlling the base station. The network device 102 may also include a relay station (a relay device), an access point, and a base station in future 5G networks, a future evolved PLMN network, or an NR base station. The network device 102 can be a wearable device or an in-vehicle device. The network device 102 can also be a communication chip with a communication module.

For example, the network device 102 includes but is not limited to: a next-generation base station (gnodeB, gNB) in 5G, an evolved node B (eNB) in an LTE system, a radio network controller (RNC), a node B (NB) in a WCDMA system, a wireless controller in a CRAN system, a base station controller (BSC), a base transceiver station (BTS) in a GSM or CDMA system, and a home base station (e.g., home evolved node B, or home node B, HNB), a baseband unit (BBU), a transmitting or receiving point (TRP), a transmitting point (TP), or a mobile switching center, etc.

Wireless Sensing is a radio recognition technology that can include multiple modes. For example, in the first sensing mode, the transmitting end and the receiving end of signals are at the same wireless transceiver device using a Time of Flight (TOF) sensor. That is, in this mode, the transmitting end and the receiving end are at the same device. In the second sensing mode, the receiving end receives signals from another device as the transmitting end using the TOF sensor, that is, the transmitting end and the receiving end are at different devices. In the third sensing mode, the receiving end receives signals from the transmitting end using the peer-to-peer aware communication (PAC), where the PAC device has communication and ranging capabilities.

For the UE 101 that supports sensing signal transmission and reception capabilities, the first sensing mode is applied. Therefore, it is necessary to solve the problem of conflicts between sensing signal transmission or reception and cellular signal transmission or reception of the UE.

The embodiments of the present disclosure provide a method for transmitting or receiving indication information. FIG. 2 is a flowchart of a method for transmitting or receiving indication information according to an exemplary embodiment. As shown in FIG. 2, the method includes steps S201-S202.

In step S201, the network device 102 transmits indication information to user equipment 101, where the indication information is configured to indicate priority of a sensing signal and/or priority of a cellular signal.

In some embodiments, the network device 102 transmits indication information via Radio Resource Control (RRC).

In an embodiment, the network device 102 transmits an RRCReconfiguration message to the user equipment, where the RRCReconfiguration message includes indication information to indicate the priority of at least one of the sensing signal or the cellular signal.

In some embodiments, the network device 102 may only indicate the priority of one of the sensing signal or the cellular signal.

In an embodiment, the network device 102 only indicates that the priority of the sensing signal is the highest, that is, the priority of the sensing signal is higher than the priority of the cellular signal. Or, the network device 102 only indicates that the priority of the sensing signal is the lowest, that is, the priority of the sensing signal is lower than the priority of the cellular signal.

In another embodiment, the network device 102 only indicates that the priority of the cellular signal is the highest, that is, the priority of the cellular signal is higher than the priority of the sensing signal; and conversely, the same applies.

In some embodiments, the network device 102 separately indicates the priority of the sensing signal and the priority of the cellular signal.

In some embodiments, the indication information includes a bit for indicating the priority.

In an embodiment, the network device 102 configures 1, 2, or more bits for indicating the priority of at least one of the sensing signal or the cellular signal.

In some embodiments, when the network device 102 only indicates the priority of one of the sensing signal or the cellular signal, a 1-bit indication can be configured.

In an embodiment, when only the priority of the sensing signal is indicated, the 1 bit being “0” indicates that the priority of the sensing signal is the highest, i.e., higher than the cellular signal; and the 1 bit being “1” indicates that the sensing signal has the lowest priority, i.e., lower than the cellular signal. Other embodiments where only the priority of the cellular signal is indicated through 1 bit can be referred to the description in this embodiment.

In some embodiments, when the network device 102 only indicates the priority of one of the sensing signal or the cellular signal, a 2-bit indication can be configured.

In an embodiment, when only the priority of the sensing signal is indicated, the 2 bits being “00” indicates that the priority of the sensing signal is the highest, i.e., higher than the cellular signal; and the 2 bits being “11” indicates that the sensing signal has the lowest priority, i.e., lower than the cellular signal. Other embodiments where only the priority of the cellular signal is indicated through 2 bits can be referred to the description in this embodiment.

In some embodiments, when the network device 102 separately indicates the priority of the sensing signal and the cellular signal, 2 bits can be configured for indicating.

In an embodiment, the 2 bits being “00” indicates that the priority of the sensing signal is higher than the priority of the cellular signal. The 2 bits being “11” indicates that the priority of the sensing signal is lower than the priority of the cellular signal.

In some embodiments, when the network device 102 separately indicates the priority of the sensing signal and the priority of the cellular signal, 2 bits can be configured for each of the sensing signal and the cellular signal, that is, 2 bits are configured for indicating the priority of the sensing signal, and another 2 bits are configured for indicating the priority of the cellular signal.

In an embodiment, the two bits corresponding to the sensing signal being “00” and the two bits corresponding to the cellular signal being “11”indicates that the priority of the sensing signal is higher than the priority of the cellular signal.

In step S202, in response to a conflict between a time-domain resource of the sensing signal and a time-domain resource of the cellular signal, the user equipment 101 transmits or receives the sensing signal or the cellular signal according to the indication information.

In some embodiments, the network device 102 may configure the time-domain resource for the user equipment 101 to transmit or receive the cellular signal. For the user equipment 101 that supports the capability of sensing signal transmission and receiving in this embodiment, the network device 102 can further configure the time-domain resource for the sensing signal to enable the user equipment 101 to sense the surrounding environment.

In some embodiments, the cellular signal includes, but is not limited to, an uplink signal and a downlink signal based on the cellular network.

In some embodiments, when there is an overlap between the time-domain position of the UE transmitting or receiving the sensing signal and the time-domain position of the UE transmitting or receiving the cellular signal, there may be a time-domain resource conflict between the sensing signal and the cellular signal.

In an embodiment, the time domain resource for the UE transmitting or receiving the sensing signal conflicts with the time domain resource for the UE transmitting the uplink signal.

In an embodiment, the time domain resource of the UE transmitting or receiving the sensing signal conflicts with the time domain resource of the UE receiving the downlink signal from the serving cell.

In an embodiment, the time domain resource for the UE transmitting or receiving the sensing signal conflicts with the time domain resource for the UE receiving the downlink signal from a neighbor cell.

In some embodiments, the user equipment 101 can determine, based on the indication information, the priority of the sensing signal and the priority of the cellular signal, or determine the signal with higher priority among the two signals.

In some embodiments, in step S202, the sensing signal or the cellular signal is transmitted or received based on the indication information, which may include the following step S202-10 (not shown).

In step S202-10, if the priority of the cellular signal is higher than the priority of the sensing signal, the user equipment 101 transmits or receives the cellular signal.

In some embodiments, based on indication information, if the priority of the cellular signal is the highest, or if the priority of the sensing signal is the lowest, or if the priority of the cellular signal is higher than the priority of the sensing signal, the user equipment 101 transmits or receives the cellular signal without receiving or transmitting the sensing signal.

In an embodiment, when the time domain resource of the UE for transmitting or receiving the sensing signal conflicts with the time domain resource of the UE for transmitting the uplink signal, if the priority of the cellular signal is high, the UE transmits the uplink signal but does not transmit or receive the sensing signal in the conflicting time domain resource.

In an embodiment, when the time domain resource of the UE transmitting or receiving the sensing signal conflicts with the time domain resource of the UE receiving the downlink signal from the serving cell, if the priority of the cellular signal is high, the UE receives the downlink signal from the serving cell but does not transmit or receive the sensing signal in the conflicting time domain resource.

In an embodiment, when the time domain resource of the UE transmitting or receiving the sensing signal conflicts with the time domain resource of the UE receiving the downlink signal from the neighbor cell, if the priority of the cellular signal is high, the UE receives the downlink signal from the neighbor cell but does not transmit or receive the sensing signal in the conflicting time domain resource. This example, for example, is for a scenario of mobility measurement.

In some embodiments, in step S202, the sensing signal or the cellular signal is transmitted or received based on the indication information, which may include the following step S202-20 (not shown).

In step S202-20, in response to the priority of the sensing signal being higher than the priority of the cellular signal, the user equipment 101 transmits or receives the sensing signal according to configuration information, where the configuration information includes a measurement gap for transmitting or receiving the sensing signal.

In some embodiments, when the priority of the sensing signal is high, the user equipment 101 needs to stop transmitting or receiving the cellular signal and transmit or receive the sensing signal within the conflicting time domain resource.

In some embodiments, during the execution of this step, based on the measurement gap (MG) configured by the configuration information, the user equipment 101 receives or transmits the sensing signal within the time domain resource corresponding to the measurement gap, and interrupts the transmission and reception of the cellular signal.

In an embodiment, when the time domain resource of the UE transmitting or receiving the sensing signal conflicts with the time domain resource of the UE transmitting the uplink signal, if the priority of the sensing signal is high, the UE transmits or receives the sensing signal and does not perform uplink signal scheduling in the time domain resource corresponding to the measurement gap.

In an embodiment, when the time domain resource of the UE transmitting or receiving the sensing signal conflicts with the time domain resource of the UE receiving the downlink signal from the serving cell, if the priority of the sensing signal is high, the UE transmits or receives the sensing signal and does not receive the downlink signal from the serving cell in the time domain resource corresponding to the measurement gap. In this example, the network device 102 does not perform downlink scheduling during the measurement gap.

In an embodiment, when the time domain resource of the UE transmitting or receiving the sensing signal conflicts with the time domain resource of the UE receiving the downlink signal from the neighbor cell, if the priority of the sensing signal is high, the UE transmits or receives the sensing signal and does not receive the downlink signal from the neighbor cell in the time domain resource corresponding to the measurement gap.

In the embodiments of the present disclosure, the user equipment 101 determines the priority of at least one of the sensing signal or the cellular signal based on the indication information transmitted by the network device 102, such that when there is a time-domain conflict between the sensing signal and the cellular signal, the user equipment 101 can perform reasonable scheduling based on the priority.

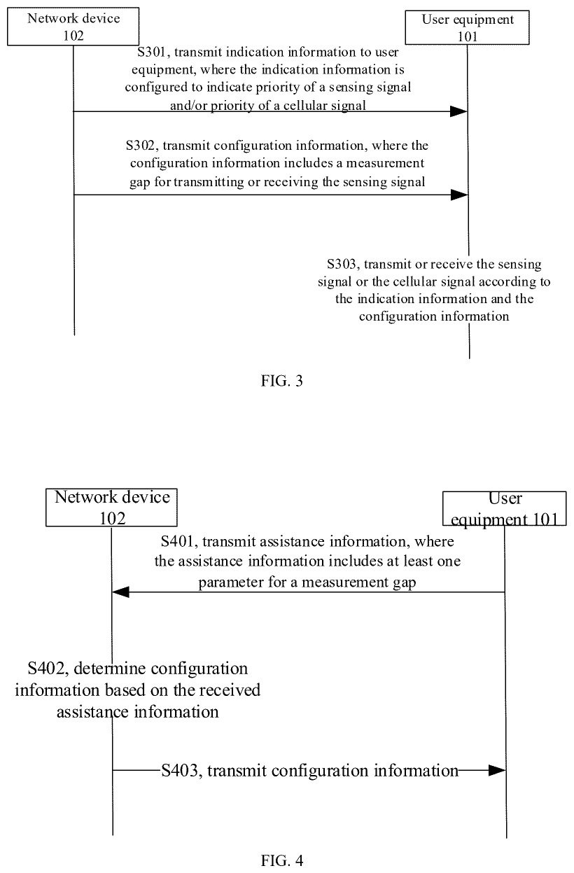

The embodiments of the present disclosure provide a method for transmitting or receiving configuration information. FIG. 3 is a flowchart of a method for transmitting or receiving configuration information according to an exemplary embodiment. As shown in FIG. 3, the method includes steps S301-S303.

In step S301, the network device 102 transmits indication information to user equipment, where the indication information is configured to indicate priority of a sensing signal and/or priority of a cellular signal.

In step S302, the network device 102 transmits configuration information to the user equipment 101, where the configuration information includes a measurement gap for transmitting or receiving the sensing signal.

In some embodiments, the network device 102 simultaneously transmits indication information and configuration information. For example, the transmitted configuration information includes the measurement configuration for the measuring gap and indication information. Thus, the network device 102 can configure the same signaling to configure the measurement gap and the indication information, which can be applied to different priority scenarios of two signals and reduce signaling interaction between the UE and the network device 102.

In some embodiments, the network device 102 may transmit indication information and configuration information separately to the user equipment 101.

In some embodiments, step 302 may be performed when the priority of the sensing signal is high. For example, step 302 may include the following step 302′ (not shown).

In step 302′, if the priority of the sensing signal is higher than the priority of the cellular signal, the network device 102 transmits configuration information to user equipment 101.

In this embodiment, in scenarios where the conflict exists, when the priority of the cellular signal is high, there is no need to configure the measurement gap. Therefore, the network device 102 may not transmit configuration information to save signaling.

In some embodiments, the configuration information includes at least one of the following parameters for the measurement gap: a type of the measurement gap being periodic or non-periodic; measurement gap duration; or a time-domain position of the measurement gap.

In some embodiments, when the measurement gap is a periodic measurement gap, the time-domain position of the measurement gap includes the measurement gap offset and the measurement gap period.

In some embodiments, when the measurement gap is a non-periodic measurement gap, the time-domain position of the measurement gap includes the starting position of the measurement gap, such as the System Frame Number (SFN) and the subframe number where the measurement gap is located.

In step S303, in response to a conflict between a time-domain resource of the sensing signal and a time-domain resource of the cellular signal, the user equipment 101 transmits or receives the sensing signal or the cellular signal according to the indication information and the configuration information.

In some embodiments, when the priority of the sensing signal is high, the user equipment 101 transmits or receives the sensing signal during the measurement gap.

In some embodiments, when the priority of the sensing signal is high, the network device 102 does not perform downlink scheduling within the time-domain resource corresponding to the measurement gap.

These embodiments of the present disclosure can be applied to scenarios where the priority of the sensing signal is higher than the priority of the cellular signal. The network device 102 configures for the user equipment 101 the measurement gap for transmitting or receiving the sensing signal. The user equipment 101 determines the time-domain position of the measurement gap based on the configuration information and transmits or receives the sensing signal during the measurement gap. During the measurement gap, the user equipment 101 and the network device 102 do not schedule the cellular signal.

The embodiments of the present disclosure provide a method for transmitting or receiving assistance configuration information. FIG. 4 is a flowchart of a method for transmitting or receiving assistance configuration information according to an exemplary embodiment. As shown in FIG. 4, the method includes steps S401-S403.

In step S401, the user equipment 101 transmits assistance information to the network device 102, where the assistance information includes at least one parameter for a measurement gap.

In step S402, the network device 102 determines configuration information based on the received assistance information.

In some embodiments, the at least one parameter for the measurement gap in the assistance information includes: a type of the measurement gap being periodic or non-periodic; measurement gap duration; or a time-domain position of the measurement gap.

In some embodiments, when the measurement gap is a periodic measurement gap, the time-domain position of the measurement gap includes the measurement gap offset and the measurement gap period.

In some embodiments, when the measurement gap is a non-periodic measurement gap, the time-domain position of the measurement gap includes the starting position of the measurement gap, such as the System Frame Number (SFN) and the subframe number where the measurement gap is located.

In some embodiments, step S401 may include the following step S401′ (not shown).

In step S401′, the user equipment 101 transmits radio resource control (RRC) signaling to the network device 102, where the RRC signaling includes the assistance information.

In some embodiments, step S401 in the method can be performed before the user equipment 101 receives the indication information, or after the user equipment 101 receives the indication information.

In an embodiment, after receiving the indication information in step S201 or step S301, if the indication information indicates that the priority of the sensing signal is high, the user equipment 101 performs step S401.

In another embodiment, the user equipment 101 reports to the network device 102 in advance for the network device 102 to determine configuration information in advance. The predetermined configuration information can be transmitted to the user equipment 101 when needed.

In step S403, the network device 102 transmits configuration information to the user equipment 101.

In some embodiments, the network device 102 may transmit an RRC message, where the RRC message includes the configuration information.

In the embodiments of the present disclosure, the user equipment 101 can report assistance information to network device 102, and the network device 102 can configure the measurement gap based on the assistance information to provide a reasonable time-domain resource for the transmission and reception of a sensing signal.

Based on the same concept as the previously described method embodiments, the embodiments of the present disclosure further provide a user equipment 101 for executing the steps performed by the user equipment 101 provided in the embodiments.

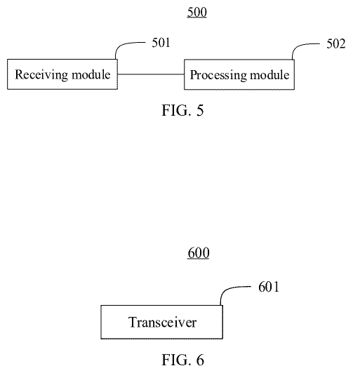

In an embodiment, the apparatus 500 shown in FIG. 5 can serve as the user equipment 101 involved in the method embodiments and execute the steps performed by the user equipment 101 in any of the method embodiments.

The apparatus 500 includes a transceiver module 501 and a processing module 502.

The transceiver module 501 is configured to receive indication information transmitted by a network device, where the indication information is configured to indicate priority of a sensing signal and/or priority of a cellular signal.

The processing module 502 is configured to, in response to a conflict between a time-domain resource of the sensing signal and a time-domain resource of the cellular signal, transmit or receive the sensing signal or the cellular signal according to the indication information.

The embodiments of the present disclosure further provide a communication device including one or more processors, and one or more memories.

The one or more memories are configured to store a computer program.

The one or more processors are configured to execute the computer program to implement the method performed by the user equipment 101.

The embodiments of the present disclosure further provide a non-transitory computer-readable storage medium storing instructions, where a computer, when calling and executing the instructions, performs the method performed by the user equipment.

Based on the same concept as the method embodiments, the embodiments of the present disclosure further provide a network device 102 for executing the steps performed by the network device 102 provided in the embodiments. Additionally, the network device 102 can be the apparatus 500 of FIG. 5.

In an embodiment, the apparatus 600 shown in FIG. 6 can serve as the user equipment 101 or the network device 102 involved in the method embodiments and execute the steps performed by the user equipment 101 or the network device 102 in any of the method embodiments.

The apparatus 600 includes a transceiver module 601.

The transceiver module 601 is configured to transmit indication information to user equipment, where the indication information is configured to indicate priority of a sensing signal and/or priority of cellular signal.

The embodiments of the present disclosure further provide a communication device including one or more processors, and one or more memories.

The one or more memories are configured to store a computer program.

The one or more processors are configured to execute the computer program to implement the methods performed by the network device 102.

The embodiments of the present disclosure further provide a non-transitory computer-readable storage medium storing instructions, where a computer, when calling and executing the instructions, performs the method performed by the network device 102.

Other implementations of the present disclosure will be apparent to those skilled in the art from consideration of the specification and practice of the present disclosure herein. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described herein and shown in the accompanying drawings and may be modified or changed without departing from the scope of the present disclosure. The scope of protection of the present disclosure is limited only by the appended claims.

### Industrial Applicability

In the embodiments of the present disclosure, the user equipment determines the priority of at least one of the sensing signal or the cellular signal based on the indication information transmitted by the network device, such that when there is a time-domain conflict between the sensing signal and the cellular signal, the user equipment can perform reasonable scheduling based on the priority.

1. A method for receiving indication information, performed by user equipment, comprising:
receiving indication information transmitted by a network device, wherein the indication information is configured to indicate priority of at least one of a sensing signal, or priority of a cellular signal; and
in response to a conflict between time-domain a resource of the sensing signal and a time-domain resource of the cellular signal, transmitting or receiving at least one of the sensing signal or the cellular signal according to the indication information.

2. The method according to claim 1, wherein transmitting or receiving at least one of the sensing signal or the cellular signal based on the indication information comprises:
in response to the priority of the cellular signal being higher than the priority of the sensing signal, transmitting or receiving the cellular signal.

3. The method according to claim 1, wherein transmitting or receiving at least one of the sensing signal or the cellular signal based on the indication information comprises:
in response to the priority of the sensing signal being higher than the priority of the cellular signal, transmitting or receiving the sensing signal according to configuration information, wherein the configuration information comprises a measurement gap for transmitting or receiving the sensing signal.

4. The method according to claim 3, wherein transmitting or receiving the sensing signal based on the configuration information comprises:
according to the configuration information, transmitting or receiving the sensing signal within a time-domain resource corresponding to the measurement gap.

5. The method according to claim 1, wherein the method further comprises:
receiving configuration information transmitted by the network device.

6. The method according to claim 5, further comprising:
transmitting assistance information to the network device, wherein the assistance information comprises at least one parameter for a measurement gap.

7. The method according to claim 6, wherein the at least one parameter comprises at least one of:
a type of the measurement gap being periodic or non-periodic;
measurement gap duration; or
a time-domain position of the measurement gap.

8. The method according to claim 6, wherein transmitting the assistance information to the network device comprises:
transmitting radio resource control (RRC) signaling to the network device, wherein the RRC signaling comprises the assistance information.

9. A method for transmitting indication information, performed by a network device, comprising:
transmitting indication information to user equipment, wherein the indication information is configured to indicate priority of at least one of a sensing signal and/or priority of a cellular signal.

10. The method according to claim 9, further comprising:
in response to the priority of the sensing signal being higher than the priority of the cellular signal, transmitting configuration information to the user equipment, wherein the configuration information comprises a measurement gap for transmitting or receiving the sensing signal.

11. The method according to claim 9, wherein the method further comprises:
according to assistance information transmitted by the user equipment, determining configuration information, wherein the assistance information comprises at least one parameter for a measurement gap; and
transmitting the configuration information to the user equipment.

12. The method according to claim 11, wherein the configuration information comprises at least one of following parameters for the measurement gap:
a type of the measurement gap being periodic or non-periodic;
measurement gap duration; or
a time-domain position of the measurement gap.

13. The method according to claim 10, further comprising:
not performing downlink scheduling within a time-domain resource corresponding to the measurement gap.

14. -15. (canceled)

16. A communication device, comprising:
one or more processors; and
one or more memories storing a computer program, wherein program;
the one or more processors are configured to execute the computer program, to implement the method according to claim 1.

17. A communication device, comprising:
one or more processors; and
one or more memories storing a computer program, wherein
the one or more processors are configured to execute the computer program, to implement the method according to-any one of claim 9.

18. A non-transitory computer-readable storage medium storing instructions, wherein a computer, when calling and executing the instructions, performs the method according to claim 1.

19. A non-transitory computer-readable storage medium storing instructions, wherein a computer, when calling and executing the instructions, performs the method according to claim 9.

20. A communication system, comprising:
a network device for transmitting indication information to user equipment, wherein the indication information is configured to indicate priority of at least one of a sensing signal or priority of a cellular signal; and
user equipment for performing the method according to claim 1.
